(19) United States
(12) Patent Application Publication
(10) Pub. No.: US 2024/0071409 A1
(43) Pub. Date: Feb. 29, 2024

(54) AEROSOL QUANTITY ESTIMATION METHOD, AEROSOL QUANTITY ESTIMATION DEVICE, AND RECORDING MEDIUM

(71) Applicant: Panasonic Intellectual Property Corporation of America, Torrance, CA (US)

(72) Inventor: Katsunori DAIMO, Osaka (JP)

(21) Appl. No.: 18/388,291

(22) Filed: Nov. 9, 2023

Related U.S. Application Data
(63) Continuation of application No. PCT/JP2022/019779, filed on May 10, 2022.

(30) Foreign Application Priority Data
May 21, 2021 (JP) 2021-085769

(51) Int. Cl. G10L 25/51; G01N 15/06; G10L 25/21

(52) U.S. Cl. CPC G10L 25/51; G01N 15/06; G10L 25/21

(57) ABSTRACT

An aerosol quantity estimation method includes: determining whether a sound pressure level of a spoken voice of a speaker is higher than a predetermined sound pressure level; calculating an acoustic feature from speech data of the spoken voice of the speaker when the sound pressure level of the spoken voice is higher than the predetermined sound pressure level; calculating a first speaker feature from the acoustic feature by using a trained model, the first speaker feature representing a speaker characteristic of the speech data; calculating a similarity between the first speaker feature and a second speaker feature that is a speaker feature of the speaker when in a calm state; and estimating a quantity of aerosols generated by the speaker, the quantity of aerosols corresponding to the similarity.

### CROSS REFERENCE TO RELATED APPLICATIONS

This is a continuation application of PCT International Application No. PCT/JP2022/019779 filed on May 10, 2022, designating the United States of America, which is based on and claims priority of Japanese Patent Application No. 2021-085769 filed on May 21, 2021. The entire disclosures of the above-identified applications, including the specifications, drawings and claims are incorporated herein by reference in their entirety.

### FIELD

The present disclosure relates to an aerosol quantity estimation method, an aerosol quantity estimation device, and a recording medium.

### BACKGROUND

Patent Literature (PTL) 1 discloses an alarm device that informs of a degree of risk of droplet transmission by measuring a sound volume level of a conversation.

### CITATION LIST

### Patent Literature

PTL 1: Japanese Utility Model Registration No. 3230254

### SUMMARY

### Technical Problem

However, it is difficult to accurately estimate a quantity of aerosols generated when a speaker speaks by measuring only sound volume level.

The present disclosure provides an aerosol quantity estimation method, an aerosol quantity estimation device, and a recording medium that can accurately estimate a quantity of aerosols generated when a speaker speaks.

### Solution to Problem

An aerosol quantity estimation method according to one aspect of the present disclosure includes: determining whether a sound pressure level of a spoken voice of a speaker is higher than a predetermined sound pressure level; calculating an acoustic feature from speech data of the spoken voice of the speaker when the sound pressure level of the spoken voice is higher than the predetermined sound pressure level; calculating a first speaker feature from the acoustic feature by using a trained model, the first speaker feature representing a speaker characteristic of the speech data; calculating a similarity between the first speaker feature and a second speaker feature that is a speaker feature of the speaker when in a calm state; and estimating a quantity of aerosols generated by the speaker, the quantity of aerosols corresponding to the similarity.

### Advantageous Effects

The present disclosure can provide an aerosol quantity estimation method, an aerosol quantity estimation device, and a recording medium that can accurately estimate a quantity of aerosols generated when a speaker speaks.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of an aerosol quantity estimation device according to an embodiment.

FIG. 2 is a block diagram of a speaker feature calculator according to the embodiment.

FIG. 3 is a flowchart of an aerosol quantity estimation process according to the embodiment.

FIG. 4 is a graph illustrating the relationship between spoken voice sound pressure level and quantity of aerosols.

FIG. 5 is a graph illustrating the correlation between aerosol quantity and similarity.

### DESCRIPTION OF EMBODIMENT

### (Underlying Knowledge Forming Basis of the Present Disclosure)

In a technique such as that described in PTL 1, the degree of risk is informed in stages by methods, such as changing the color of light emitted or changing a sound volume level, according to the degree of risk based on a sound volume level of a conversation. However, the approximate amount of aerosols generated by a person speaking (speaker) is not estimated.

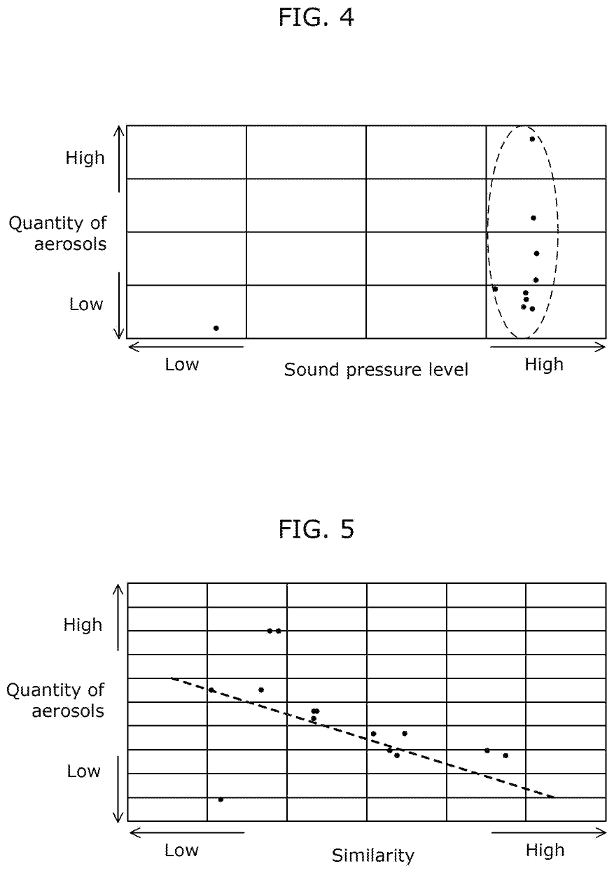

FIG. 4 is a graph illustrating the relationship between spoken voice sound pressure level and quantity of aerosols. As illustrated in the graph in FIG. 4, since there is variation in quantity of aerosols generated once the sound pressure level reaches or exceeds a certain level, it is difficult to accurately estimate quantity of aerosols by measuring only sound pressure level.

As illustrated in FIG. 5, the inventors have found that the quantity of aerosols generated when a speaker makes an utterance is correlated with the similarity between the speech characteristics of that utterance and the speech characteristics of the speaker when he or she is calm. Accordingly, the inventors have found an aerosol quantity estimation method that can accurately estimate a quantity of aerosols generated when a speaker speaks by using this similarity as an index for estimating quantities of aerosols.

An aerosol quantity estimation method according to one aspect of the present disclosure includes: determining whether a sound pressure level of a spoken voice of a speaker is higher than a predetermined sound pressure level; calculating an acoustic feature from speech data of the spoken voice of the speaker when the sound pressure level of the spoken voice is higher than the predetermined sound pressure level; calculating a first speaker feature from the acoustic feature by using a trained model, the first speaker feature representing a speaker characteristic of the speech data; calculating a similarity between the first speaker feature and a second speaker feature that is a speaker feature of the speaker when in a calm state; and estimating a quantity of aerosols generated by the speaker, the quantity of aerosols corresponding to the similarity.

With this, when the sound pressure level of the spoken voice of the speaker is higher than the predetermined sound pressure level, the aerosol quantity estimation method calculates the first speaker feature using the model trained to identify the speaker characteristic, and estimates the quantity of aerosols corresponding to the similarity between the first speaker feature and the second speaker feature of the speaker when in a calm state. By calculating the similarity and making use of a correlation between the quantity of aerosols and the similarity between the speech characteristics when the speaker is speaking and the speech characteristics of the speaker when in a calm state, the aerosol quantity estimation method can accurately estimate the quantity of aerosols generated by the speaker.

Furthermore, in the estimating, the quantity of aerosols corresponding to the similarity may be estimated based on a correlation in which the quantity of aerosols generated is higher as the similarity is lower.

Furthermore, in the estimating: a quantity of aerosols generated per predetermined unit of time may be estimated at intervals of the predetermined unit of time to obtain quantities of aerosols; and a cumulative value of the quantities of aerosols obtained from a start of the estimating may be calculated.

Accordingly, a total amount of the quantities of aerosols generated from the start of the estimating can be estimated, and a risk of infection based on the quantity of aerosols can thus be effectively assessed.

Furthermore, the aerosol quantity estimation method may further include: determining whether the cumulative value is larger than a predetermined quantity of aerosols; and issuing a warning when the cumulative value is larger than the predetermined quantity of aerosols.

Accordingly, a warning can be issued when the risk of infection is determined to be high, and a user can thus be encouraged to take measures to reduce the quantity of aerosols generated.

Furthermore, the aerosol quantity estimation method may further include: determining whether the cumulative value is larger than a predetermined quantity of aerosols; and causing at least one of a ventilator or an air purifier to operate when the cumulative value is larger than the predetermined quantity of aerosols, the at least one of the ventilator or the air purifier being disposed in a space where the speaker is present.

Accordingly, at least one of the ventilator or the air purifier can be caused to operate when the risk of infection is determined to be high, and the quantity of aerosols can thus be effectively reduced.

Furthermore, the second speaker feature may represent a speaker characteristic of speech data obtained by having the speaker read aloud a predetermined passage of text.

An aerosol quantity estimation device according to one aspect of the present disclosure includes: a sound pressure level determiner that determines whether a sound pressure level of a spoken voice of a speaker is higher than a predetermined sound pressure level; an acoustic feature calculator that calculates an acoustic feature from speech data of the spoken voice of the speaker when the sound pressure level of the spoken voice is higher than the predetermined sound pressure level; a speaker feature calculator that calculates a first speaker feature from the acoustic feature by using a trained model, the first speaker feature representing a speaker characteristic of the speech data; a similarity calculator that calculates a similarity between the first speaker feature and a second speaker feature that is a speaker feature of the speaker when in a calm state; and an estimator that estimates a quantity of aerosols generated by the speaker, the quantity of aerosols corresponding to the similarity.

With this, when the sound pressure level of the spoken voice of the speaker is higher than the predetermined sound pressure level, the aerosol quantity estimation method calculates the first speaker feature using the model trained to identify the speaker characteristic, and estimates the quantity of aerosols corresponding to the similarity between the first speaker feature and the second speaker feature of the speaker when in a calm state. By calculating the similarity and by making use of a correlation between the quantity of aerosols and the similarity between the speech characteristics when the speaker is speaking and the speech characteristics of the speaker when in a calm state, the aerosol quantity estimation method can accurately estimate the quantity of aerosols generated by the speaker.

A recording medium according to one aspect of the present disclosure is a non-transitory computer-readable recording medium having recorded thereon a program for causing a computer to execute the aerosol quantity estimation method.

It should be noted that these generic and specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, an embodiment will be described in detail with reference to the drawings. It should be noted that the embodiment described below merely illustrates a specific example of the present disclosure. The numerical values, shapes, materials, elements, the arrangement and connection of the elements, steps, the order of the steps, etc., described in the following embodiment are mere examples, and are therefore not intended to limit the present disclosure. Accordingly, among elements in the following embodiment, those not appearing in any of the independent claims will be described as optional elements.

### Embodiment 1

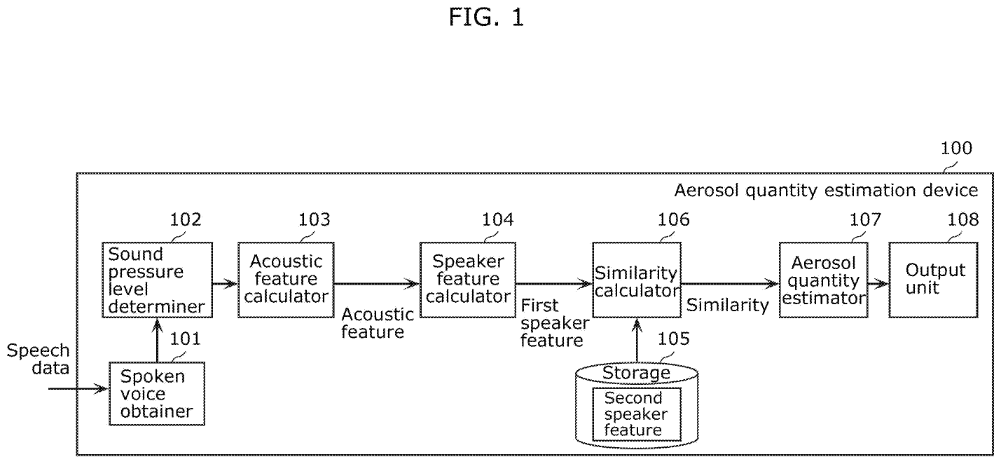

FIG. 1 is a block diagram illustrating a configuration of aerosol quantity estimation device 100 according to this embodiment. Aerosol quantity estimation device 100 estimates a quantity of aerosols generated by a speaker (user). Specifically, the quantity of aerosols is the amount of minute particles of fluids including saliva expelled by the speaker into the space where the speaker is present when the speaker speaks. For example, aerosol quantity estimation device 100 is included in a terminal device, such as a smartphone or tablet device. Furthermore, the functions of aerosol quantity estimation device 100 may be implemented by a single device or by multiple devices. For example, a portion of the functions of aerosol quantity estimation device 100 may be implemented by the terminal device, and another portion of the functions may be implemented by a server, or the like, capable of communicating with the terminal device.

As illustrated in FIG. 1, aerosol quantity estimation device 100 includes spoken voice obtainer 101, sound pressure level determiner 102, acoustic feature calculator 103, speaker feature calculator 104, storage 105, similarity calculator 106, aerosol quantity estimator 107, and output unit 108.

Spoken voice obtainer 101 obtains speech data that is spoken voice data of the speaker. Spoken voice obtainer 101 is, for example, a microphone, and generates speech data by converting the spoken voice obtained into an audio signal. It should be noted that spoken voice obtainer 101 may obtain speech data generated outside of aerosol quantity estimation device 100.

Sound pressure level determiner 102 measures the sound pressure level of the spoken voice from the speech data, and determines whether the sound pressure level measured is higher than a predetermined sound pressure level. It should be noted that the sound pressure level of the spoken voice may, for example, be an amplitude of a peak of an audio waveform of a predetermined period of time of the speech data. When there are a plurality of peaks in the predetermined period of time, the sound pressure level of the spoken voice of the speech data may be the maximum value of the amplitudes of the plurality of peaks, or may be the average value of the amplitudes of the plurality of peaks. The predetermined period of time is, for example, a period of time from a time preceding the current time (latest time) by a first interval of time up to the current time. The first interval of time may, for example, be time amounting to 100 seconds or less. Furthermore, the magnitude of sound indicated by spoken voice data may be the amplitude at the current time of an envelope curve formed by a curve tangential to the peaks of an audio waveform of the sound data, may be the maximum value for a predetermined period of time of the envelope curve, or may be the average value for the predetermined period of time of the envelope curve.

Acoustic feature calculator 103 calculates an acoustic feature of the spoken voice from the speech data when sound pressure level determiner 102 determines that the sound pressure level of the spoken voice of the speaker is higher than the predetermined sound pressure level. For example, acoustic feature calculator 103 calculates, as the acoustic feature, a mel-frequency cepstral coefficient (MFCC), which is a feature of the spoken voice, from the speech data. An MFCC is a feature that represents vocal-tract characteristics of a speaker that is also commonly used in voice recognition. More specifically, an MFCC is an acoustic feature obtained by analyzing the frequency spectrum of a spoken voice, based on human auditory characteristics. It should be noted that acoustic feature calculator 103 may calculate, as the acoustic feature from the speech data, a spoken voice signal to which a mel-filter bank has been applied, or a spectrogram of the spoken voice signal.

Speaker feature calculator 104 extracts, from the acoustic feature calculated from the speech data, a first speaker feature for identifying the speaker of the spoken voice indicated by the speech data. In other words, the first speaker feature represents a speaker characteristic of the speech data. More specifically, speaker feature calculator 104 extracts the first speaker feature from the acoustic feature by using a trained deep neural network (DNN).

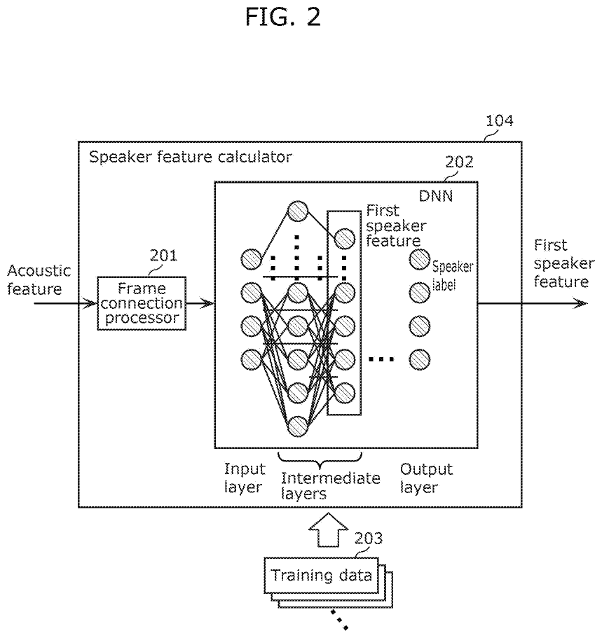

For example, speaker feature calculator 104 extracts the first speaker feature using an x-vector method. Here, the x-vector method is a method for calculating a speaker feature that is a speaker-unique characteristic called an x-vector. FIG. 2 is a block diagram illustrating an example of a configuration of speaker feature calculator 104. As illustrated in FIG. 2, speaker feature calculator 104 includes, for example, frame connection processor 201 and DNN 202.

Frame connection processor 201 connects a plurality of acoustic features and outputs the acoustic features obtained to DNN 202. For example, frame connection processor 201 connects a plurality of frames of an MFCC, which are acoustic features, and outputs the acoustic features to an input layer of DNN 202. For example, frame connection processor 201 connects 50 frames of MFCC parameters composed of features with 24 dimensions per frame to generate a 1,200-dimensional vector, and outputs the vector generated to the input layer of DNN 202.

DNN 202 is a trained machine learning model that outputs a first speaker feature corresponding to the acoustic features inputted. In the example illustrated in FIG. 2, DNN 202 is a neural network that includes an input layer, a plurality of intermediate layers, and an output layer. Furthermore, DNN 202 is created in advance by machine learning using a plurality of training data 203. Each of the plurality of training data 203 is data that links information for identifying a speaker to speech data of the speaker. That is to say, although DNN 202 is a trained model that receives speech data as input and outputs information for identifying the speaker of the speech data (speaker label), in the present embodiment, DNN 202 outputs the first speaker feature generated as intermediate data. It should be noted that a trained machine learning model trained by machine learning other than DNN machine learning may be used in place of DNN 202.

More specifically, the output layer includes nodes that output speaker labels for the number of speakers included in training data 203. The plurality of intermediate layers include two to three layers of intermediate layers, for example, and include an intermediate layer that calculates the first speaker feature. The intermediate layer that calculates the first speaker feature outputs, as the output of DNN 202, the first speaker feature calculated.

Storage 105 is configured, for example, of rewritable non-volatile memory, such as a hard disk drive, solid state drive, or the like. Storage 105 stores a second speaker feature that is the first speaker feature of the speaker when he or she is healthy. For example, the second speaker feature is a speaker feature obtained in advance from speech data of the spoken voice of the speaker when in a calm state. The speech data of the spoken voice of the speaker when in a calm state is, for example, speech data obtained by having the speaker read aloud a predetermined passage of text. Furthermore, the speech data of the spoken voice of the speaker when in a calm state may be speech data of the spoken voice when the speaker is estimated to be calm (at rest) based on biometric information, such as bodily movement, heart rate, body temperature, sweating, voice, and facial expression of the speaker. It should be noted that the second speaker feature may be calculated from a plurality of first speaker features obtained during a plurality of aerosol quantity estimation processes performed in the past. For example, the second speaker feature may be the average value or the median value of the plurality of first speaker features obtained during the plurality of aerosol quantity estimation processes performed in the past.

Similarity calculator 106 calculates a similarity (degree of similarity) between the first speaker feature outputted from speaker feature calculator 104 and the second speaker feature stored in storage 105. For example, similarity calculator 106 calculates, as the similarity, a cosine distance (also called a cosine similarity) indicating the angle formed between the vectors of the first speaker feature and the second speaker feature, by calculating a cosine using an inner product in a vector space model. In this case, a larger numerical value of the angle formed between the vectors indicates lower similarity. It should be noted that similarity calculator 106 may calculate, as the similarity, a cosine distance that takes a value from −1 to 1, using an inner product of the vector that represents the first speaker feature and the vector that represents the second speaker feature. In this case, a larger numerical value indicating cosine distance indicates higher similarity. It should be noted that higher similarity indicates more similarity between the first speaker feature and the second speaker feature, and lower similarity indicates less similarity between the first speaker feature and the second speaker feature.

Aerosol quantity estimator 107 estimates a quantity of aerosols generated by the speaker based on the similarity calculated by similarity calculator 106. Specifically, aerosol quantity estimator 107 estimates a quantity of aerosols corresponding to the similarity by using a correlation, as illustrated in FIG. 5, in which quantity of aerosols generated is higher as similarity is lower. This correlation may be a correlation between similarity and quantity of aerosols generated over intervals of a predetermined unit of time.

Here, each of the processes performed by spoken voice obtainer 101, sound pressure level determiner 102, acoustic feature calculator 103, speaker feature calculator 104, and similarity calculator 106 may be repeatedly performed at predetermined intervals of time. In this case, aerosol quantity estimator 107 estimates quantities of aerosols generated over intervals of a predetermined unit of time in cases where sound pressure level determiner 102 determines that the sound pressure level of a spoken voice is higher than the predetermined sound pressure level, and calculates a cumulative value of the quantities of aerosols obtained from the start of the estimation process. Accordingly, a total amount of the quantities of aerosols generated from the start of the estimating process can be estimated, and the risk of infection based on the quantity of aerosols can thus be effectively assessed.

Furthermore, aerosol quantity estimator 107 may determine whether the cumulative value calculated is larger than a predetermined quantity of aerosols, and when the cumulative value is larger than the predetermined quantity of aerosols, aerosol quantity estimator 107 may determine that the risk of infection by an infectious disease is high. It should be noted that aerosol quantity estimator 107 may determine if there is a risk of infection instead of determining whether the risk of infection is high. For example, aerosol quantity estimator 107 may determine a higher risk of infection for a lower similarity. It should be noted that the determination result may be indicated by multi-level classifications, such as “there is a risk of infection”, “risk of infection is high”, and “risk of infection is extremely high”, and may be indicated by numerical values indicating the risk of infection or the like.

Output unit 108 notifies the speaker of the determination result obtained by aerosol quantity estimator 107. For example, output unit 108 is a display or a loudspeaker included in a terminal device, and notifies the speaker of the determination result by display or by sound. It should be noted that output unit 108 may output the determination result to an external device. It should be noted that output unit 108 may notify the speaker of the determination result (e.g., warning indicating that the risk of infection is high) exclusively in cases where the risk of infection is determined to be high. Accordingly, a warning can be issued when the risk of infection is determined to be high, and the user can be encouraged to take measures to reduce the quantity of aerosols generated.

Furthermore, when the risk of infection is determined to be high, output unit 108 may operate a ventilator and/or an air purifier provided in the space where the speaker is present. Specifically, when the risk of infection is determined to be high, output unit 108 may operate a ventilator and/or an air purifier by sending, to the ventilator and/or the air purifier, a control signal for causing the ventilator and/or the air purifier to operate. Accordingly, a ventilator and/or an air purifier can be operated when the risk of infection is determined to be high, and the quantity of aerosols can thus be effectively reduced.

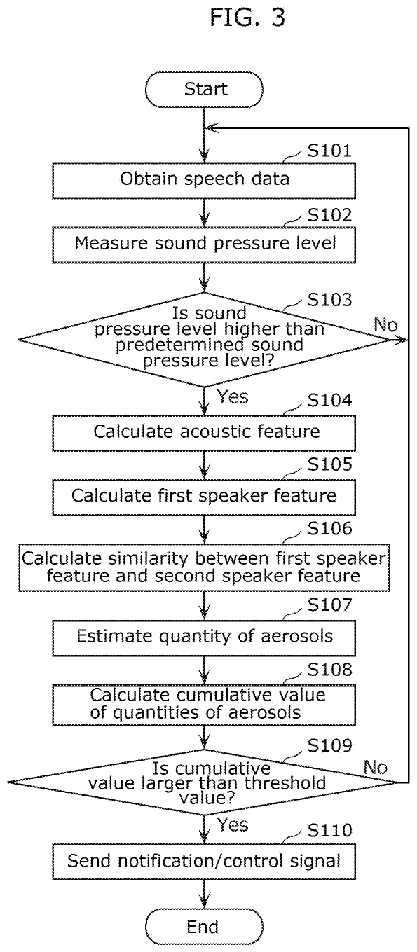

Hereinafter, an aerosol quantity estimation process performed by aerosol quantity estimation device 100 will be described. FIG. 3 is a flowchart of an aerosol quantity estimation process performed by aerosol quantity estimation device 100. It should be noted that a case where a single speaker has been registered in advance to aerosol quantity estimation device 100 will be described here.

First, in aerosol quantity estimation device 100, spoken voice obtainer 101 obtains speech data that is spoken voice data of a speaker (S101).

Next, sound pressure level determiner 102 measures the sound pressure level of the spoken voice from the speech data (S102), and determines whether the sound pressure level measured is higher than a predetermined sound pressure level (S103).

Next, when sound pressure level determiner 102 determines that the sound pressure level of the spoken voice of the speaker is higher than the predetermined sound pressure level (“Yes” in S103), acoustic feature calculator 103 calculates an acoustic feature of the spoken voice from the speech data (S104). It should be noted that when sound pressure level determiner 102 determines that the sound pressure level of the spoken voice of the speaker is less than or equal to the predetermined sound pressure level (“No” in S103), step S101 is executed.

Next, speaker feature calculator 104 calculates a first speaker feature for identifying the speaker of the spoken voice indicated by the speech data from the acoustic feature calculated from the speech data (S105). Specifically, speaker feature calculator 104 outputs a first speaker feature that corresponds to the acoustic feature inputted.

Next, similarity calculator 106 calculates the similarity between the first speaker feature outputted from speaker feature calculator 104 and a second speaker feature stored in storage 105 (S106).

Next, aerosol quantity estimator 107 estimates a quantity of aerosols generated by the speaker based on the similarity calculated by similarity calculator 106 (S107). Specifically, aerosol quantity estimator 107 estimates the quantity of aerosols generated over an interval of a predetermined unit of time corresponding to the similarity by using a correlation in which quantity of aerosols generated is higher as similarity is lower. The calculated quantity of aerosols generated over the interval of the predetermined unit of time may be stored in storage 105.

Next, aerosol quantity estimator 107 calculates a cumulative value of the quantities of aerosols obtained from the start of the estimation process (S108). Specifically, aerosol quantity estimator 107 calculates the cumulative value by adding up the total of the one or more quantities of aerosols obtained from the start of the estimation process and stored in storage 105.

Next, aerosol quantity estimator 107 determines whether the cumulative value calculated is larger than a predetermined quantity of aerosols (S109).

When the cumulative value is larger than the predetermined quantity of aerosols (“Yes” in S109), output unit 108 notifies the speaker of the determination result obtained by aerosol quantity estimator 107 (S110). It should be noted that when the cumulative value is larger than the predetermined quantity of aerosols (“Yes” in S109), output unit 108 may send a control signal for causing a ventilator and/or an air purifier to operate to the ventilator and/or the air purifier. When the cumulative value is less than or equal to the predetermined quantity of aerosols (“No” in S109), step S101 is executed.

It should be noted that although an example where a single speaker has been registered in advance is described above, a plurality of speakers may be registered. In such a case, the second speaker feature of each speaker is stored in storage 105. Furthermore, information to identify the speaker is input to aerosol quantity estimation device 100, and the above-mentioned process is executed by using the second speaker feature of the speaker identified.

As described above, aerosol quantity estimation device 100 determines whether the sound pressure level of the spoken voice of the speaker is higher than the predetermined sound pressure level. When the sound pressure level is higher than the predetermined sound pressure level, aerosol quantity estimation device 100 calculates an acoustic feature from the speech data of the spoken voice of the speaker. Aerosol quantity estimation device 100 calculates a first speaker feature that represents a speaker characteristic of the speech data, from the acoustic feature by using a trained DNN. Aerosol quantity estimation device 100 calculates the similarity between the first speaker feature and a second speaker feature that is a speaker feature of the speaker when in a calm state. Aerosol quantity estimation device 100 estimates a quantity of aerosols generated by the speaker corresponding to the similarity.

That is to say, when the sound pressure level of the spoken voice of the speaker is higher than the predetermined sound pressure level, aerosol quantity estimation device 100 calculates the first speaker feature using a trained DNN for identifying the speaker characteristic, and estimates the quantity of aerosols that corresponds to the similarity between the first speaker feature and the second speaker feature of the speaker when in a calm state. By calculating the similarity and by making use of a correlation between the quantity of aerosols and the similarity between the speech characteristics when the speaker is speaking and the speech characteristics of the speaker when in a calm state, the aerosol quantity estimation method can accurately estimate the quantity of aerosols generated by the speaker.

It should be noted that speaker feature calculator 104 is not limited to a configuration that includes frame connection processor 201 and DNN 202. Speaker feature calculator 104 calculates a physical quantity of the spoken voice from a spoken voice signal. In the present embodiment, speaker feature calculator 104 calculates, from a spoken voice signal, mel-frequency cepstrum coefficients (MFCC) that are features of a spoken voice. MFCC are features that represent vocal-tract characteristics of a speaker. It should be noted that speaker feature calculator 104 is not limited to calculating MFCC as a physical quantity of a spoken voice, and speaker feature calculator 104 may calculate a spoken voice signal to which a mel-filter bank has been applied, or may calculate a spectrogram of the spoken voice signal. Furthermore, speaker feature calculator 104 may calculate a feature of a spoken voice as a physical quantity of a spoken voice from a spoken voice signal using a DNN.

Although an aerosol quantity estimation device according to an embodiment of the present disclosure has been described above, the present disclosure is not limited to this exemplary embodiment.

Furthermore, each of the processing units included in the aerosol quantity estimation device according to the foregoing embodiment are typically implemented as a large scale integration (LSI) circuit, which is an integrated circuit. These processing units may be configured as individual chips or may be configured so that a part or all of the processing units are included in a single chip.

Furthermore, the method of circuit integration is not limited to LSIs, and implementation through a dedicated circuit or a general-purpose processor is also possible. A field programmable gate array (FPGA) that allows for programming after the manufacture of an LSI, or a reconfigurable processor that allows for reconfiguration of the connection and the setting of circuit cells inside an LSI may be employed.

Furthermore, although in each of the foregoing embodiments, the respective elements are configured using dedicated hardware, the respective elements may be implemented by executing software programs suitable for the respective elements. The respective elements may be implemented by a program executer such as a CPU or a processor reading and executing a software program recorded on a recording medium such as a hard disk or a semiconductor memory.

Furthermore, the present disclosure may be implemented as an aerosol quantity estimation method, or the like, performed by an aerosol quantity estimation device, or the like.

Furthermore, as the functional block divisions illustrated in the block diagram are merely one example, multiple functional blocks may be realized as a single functional block, a single functional block may be divided into multiple parts, and part of one function may be transferred to another functional block. Additionally, functions of multiple functional blocks including similar functions may be processed in parallel or by time-sharing, by a single piece of hardware or software.

Furthermore, the sequence in which respective steps in the flowchart are executed is given as an example to describe the present disclosure in specific terms, and thus other sequences are possible. Furthermore, part of the above-described steps may be executed simultaneously (in parallel) with another step. Although aerosol quantity estimation, and the like, according to one or more aspects are described above based on the foregoing embodiment, the present disclosure is not limited to this embodiment. The one or more aspects may thus include forms obtained by making various modifications to the above embodiment that can be conceived by those skilled in the art, as well as forms obtained by combining structural components in different embodiments, without materially departing from the spirit of the present disclosure.

### INDUSTRIAL APPLICABILITY

The present disclosure is useful as an aerosol quantity estimation method, aerosol quantity estimation device, and a recording medium, or the like, that can accurately estimate a quantity of aerosols generated when a speaker speaks.

1. An aerosol quantity estimation method comprising:
determining whether a sound pressure level of a spoken voice of a speaker is higher than a predetermined sound pressure level;
calculating an acoustic feature from speech data of the spoken voice of the speaker when the sound pressure level of the spoken voice is higher than the predetermined sound pressure level;
calculating a first speaker feature from the acoustic feature by using a trained model, the first speaker feature representing a speaker characteristic of the speech data;
calculating a similarity between the first speaker feature and a second speaker feature that is a speaker feature of the speaker when in a calm state; and
estimating a quantity of aerosols generated by the speaker, the quantity of aerosols corresponding to the similarity.

2. The aerosol quantity estimation method according to claim 1, wherein
in the estimating, the quantity of aerosols corresponding to the similarity is estimated based on a correlation in which the quantity of aerosols generated is higher as the similarity is lower.

3. The aerosol quantity estimation method according to claim 1, wherein
in the estimating:
a quantity of aerosols generated per predetermined unit of time is estimated at intervals of the predetermined unit of time to obtain quantities of aerosols; and
a cumulative value of the quantities of aerosols obtained from a start of the estimating is calculated.

4. The aerosol quantity estimation method according to claim 3, further comprising:
determining whether the cumulative value is larger than a predetermined quantity of aerosols; and
issuing a warning when the cumulative value is larger than the predetermined quantity of aerosols.

5. The aerosol quantity estimation method according to claim 3, further comprising:
determining whether the cumulative value is larger than a predetermined quantity of aerosols; and
causing at least one of a ventilator or an air purifier to operate when the cumulative value is larger than the predetermined quantity of aerosols, the at least one of the ventilator or the air purifier being disposed in a space where the speaker is present.

6. The aerosol quantity estimation method according to claim 1, wherein
the second speaker feature represents a speaker characteristic of speech data obtained by having the speaker read aloud a predetermined passage of text.

7. An aerosol quantity estimation device comprising:
a sound pressure level determiner that determines whether a sound pressure level of a spoken voice of a speaker is higher than a predetermined sound pressure level;
an acoustic feature calculator that calculates an acoustic feature from speech data of the spoken voice of the speaker when the sound pressure level of the spoken voice is higher than the predetermined sound pressure level;
a speaker feature calculator that calculates a first speaker feature from the acoustic feature by using a trained model, the first speaker feature representing a speaker characteristic of the speech data;
a similarity calculator that calculates a similarity between the first speaker feature and a second speaker feature that is a speaker feature of the speaker when in a calm state; and
an estimator that estimates a quantity of aerosols generated by the speaker, the quantity of aerosols corresponding to the similarity.

8. A non-transitory computer-readable recording medium having recorded thereon a program for causing a computer to execute the aerosol quantity estimation method according to claim 1.
